(19) United States
(12) Patent Application Publication
(10) Pub. No.: US 2008/0089060 A1
(43) Pub. Date: Apr. 17, 2008

(54) METHODS AND APPARATUS FOR IMPROVING VERSATILITY AND IMPACT RESISTANCE OF LIGHTING FIXTURES

(75) Inventors: Steve T. Kondo, Danvers, MA (US); Tomas Mollnow, Somerville, MA (US); Colin Piepgras, Swampscott, MA (US)

Correspondence Address: WOLF GREENFIELD & SACKS, P.C., 600 ATLANTIC AVENUE, BOSTON, MA, 02210-2206, US

(73) Assignee: Philips Solid-State Lighting Solutions, Burlington, MA (US)

(21) Appl. No.: 11/873,625

(22) Filed: Oct. 17, 2007

Related U.S. Application Data
(60) Provisional application No. 60/829,760, filed on Oct. 17, 2006.

(51) Int. Cl. F21V 5/00; F21V 29/00; F21V 9/08; F21V 31/00

(52) U.S. Cl. 362/231; 362/267; 362/294; 362/311

(57) ABSTRACT

A lighting apparatus includes an LED-based lighting fixture having a housing and a gasketed face panel (e.g., a lens, diffuser or other optical cover), a protective flexible sleeve removably fitted over the housing, and a bezel for sealably retaining the gasketed face panel against the housing and connected to the housing with a non-adhesive connector, so that it can be readily removed therefrom. The flexible sleeve is made from a thermoplastic material and is removably secured over the lighting fixture by a compressive force. Applications for such lighting apparatus include theatrical and rental lighting, where fixtures are exposed to rigors of frequent handling.

### CROSS-REFERENCE TO RELATED APPLICATION

This application claims the benefit, under 35 U.S.C. 119(e), of U.S. provisional application No. 60/829,760, filed on Oct. 17, 2006, the entire contents of which are hereby incorporated herein by reference.

### FIELD OF THE INVENTION

The present invention generally relates to compact LED-based lighting fixtures suitable for repeated installations, and, more particularly, to protective structures for such fixtures to provide improved versatility and impact resistance.

### BACKGROUND

Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs, for example, as discussed in detail in U.S. Pat. No. 6,016,038, incorporated herein by reference. The lighting module is typically enclosed in a housing having a lens for transmitting and/or transforming light emanating from the lighting module.

Referring to FIG. 1, one example of such an LED-based lighting fixture suitable for generating both uniform surface illumination and color-changing lighting effects in various architectural, theatrical, hospitality, and retail lighting projects is a fixture 10, including a plurality of LEDs 11 disposed in a housing 12 having either a soft-focus or a clear tempered glass lens 13 permanently attached thereto. Electronic components 17 of fixture 10, some of which are located beneath LED's 11, are visible through glass lens 13. The housing is connected to a pre-assembled mounting base 14 using a locking constant torque hinge 15, for positioning and aiming of the fixture.

In many applications, lighting fixtures, such as LED-based fixture 10, are repeatedly installed and removed. For example, in entertainment or theatrical lighting applications, lighting systems are frequently set up before a particular performance, removed after the performance is over, and then set up again for a different performance or at a different venue. As another example, lighting fixtures are often rented for short-term lighting projects, such as, for example, touring performances. Thus, over the fixtures' lifetime, they may be exposed to extensive and relatively rugged handling, e.g. dropped or knocked against other objects. As a result, the fixtures' lenses are frequently scratched or broken. Once the lens breaks, the replacement process entails (i) cutting out the scratched or broken lens material, which may be, for example, tempered glass, from the fixture; (ii) scraping and cleaning out the old adhesive; and (iii) attaching a new lens. The process is costly, time-consuming, and prone to causing injury. Also, even if the lens is intact, in many applications, it may be desirable and cost-effective to use different lenses with the same fixture to, for example, switch from soft-edge wash lighting to extended beam projection.

Conventional structures for protecting components of a lighting fixture, however, are typically permanently attached and/or are not easily removed. Often, these conventional protective components hamper access to certain parts of the fixture, making repairs and maintenance more cumbersome or impossible. Furthermore, side and/or rear surfaces of the fixture housings are typically configured for mounting an accessory holder, required for attaching any mechanical light control accessories to the fixtures. Examples of such accessories include top hats, half top hats, and barn doors, providing adjustable beam control and preventing viewers from seeing the sources of the light to minimize distraction. Further yet, theatrical lighting fixtures employing conventional light sources typically require various accessories to generate desirable lighting effects/color. These accessories, such as gels, filters, and mechanical color scrollers, typically connect at the light-emissive end of the fixture to mechanical structures, which must remain accessible during operation of the lighting fixture and which may include moving parts, thereby placing restrictions on any protective structure that may be attached at the light-emissive end of the fixture. While these accessories provide distinct functional advantages for the user, they often complicate attaching any protective structures to the fixtures or prohibit it altogether.

Furthermore, in conventional non-LED lighting fixtures, a substantial amount of the heat generated during operation is radiated out through the light-emissive surface, thereby raising its temperature appreciably. Thus, any protective structure located at or near the light-emissive surface needs to made of a material with relatively high thermal resistance, which limits the materials' selection and configuration of protective elements.

Thus, there exists a need in the art to improve the versatility and impact resistance of lighting fixtures. In particular, there exists a need for an LED-based lighting apparatus having a readily removable protective structure, which protects the fixture from damage without impeding its functionality or complicating repairs and maintenance of the fixture. There further exists a need for an improved lighting fixture in which the lens can be easily removed or replaced.

### SUMMARY

Applicants herein have recognized and appreciated that versatility of a lighting fixture subject to rugged handling during repeated installations can be improved by providing (i) a flexible protective sleeve removably fitted over the fixture's housing and (ii) a structure for sealably securing and readily removing the lens from the housing for repairs or replacement. Thus, a lighting fixture according to various implementations and embodiments of the present invention has improved shock absorption, impact resistance, and shielding from environmental elements and can be readily disassembled and reassembled for making repairs and providing maintenance.

Generally, in one aspect, the invention relates to a lighting apparatus that comprises an LED-based lighting fixture including a housing having an outer rim and at least one LED-based lighting unit disposed in the housing. The lighting apparatus also comprises a face panel having a lens portion for transmitting light emitted by the at least one LED-based lighting unit, and a flexible sleeve removably fitted over the lighting fixture and covering at least a portion of the outer rim and a portion of the face panel. The flexible sleeve may include, or consist essentially of, a thermoplastic elastomeric material and be secured over the lighting fixture by a compressive force. Also, the flexible sleeve may have a protective surface disposed proximate to and offset from a surface of the lens portion of the face panel, as well as an expanded portion disposed proximate to the outer rim. The expanded portion may have a surface offset from the protective surface. The flexible sleeve may cover between about 20% to about 60% of the face panel of the lighting fixture.

In some embodiments of this and other aspects of the invention, the at least one LED-based lighting unit includes: (i) at least one first LED adapted to output a first radiation having a first spectrum; (ii) at least one second LED adapted to output a second radiation having a second spectrum different from the first spectrum; and (iii) at least one controller disposed in the housing and coupled to the at least one first LED and the at least one second LED, the at least one controller configured to independently control at least a first intensity of the first radiation and a second intensity of the second radiation so as to controllably vary at least an overall perceivable color or color temperature of the visible radiation generated by the lighting apparatus. The lighting apparatus can be configured to provide ambient illumination including visible radiation in an environment to be occupied by an observer of the ambient illumination, such that the visible radiation includes at least one of the first radiation and the second radiation. The controller can be configured as an addressable controller capable of receiving at least one network signal including at least first lighting information relating to the overall perceivable color of the visible radiation generated by the lighting apparatus.

In many embodiments, the lighting fixture also includes a bezel disposed between the flexible sleeve and the housing for retaining the face panel. The bezel can be removably connected to the housing, for example, pivotably mounted thereto.

In another aspect, the invention relates to a lighting apparatus comprising: (i) a housing, having at least one LED-based lighting unit disposed therein; (ii) a lens for transmitting light emitted by the at least one LED-based lighting unit; and (iii) a bezel removably connected to the housing by a non-adhesive connector and adapted to sealably secure the lens against the housing. The lighting apparatus may also include a gasket disposed on the lens proximate to an outer edge thereof. The bezel can be pivotably mounted to the housing, such that the bezel is disengageable from the housing to allow access to the lens and the at least one LED-based lighting unit of the lighting apparatus.

In yet another aspect, the invention relates to a flexible sleeve for protecting a lighting fixture. The flexible sleeve is made from a thermoplastic elastomeric material that has dimensions selected to allow the sleeve to be removably affixed to the lighting fixture by a compressive force fit. In various embodiments of this and other aspects of the invention, the thermoplastic elastomeric material, as well as a thickness of the sleeve, are selected to provide a predetermined degree of shock absorption and impact resistance.

A further aspect of the invention relates to a method for enabling repairs or maintenance of an LED-based lighting apparatus, which has (i) a housing having at least one LED-based lighting unit disposed therein, (ii) a lens associated with the housing for transmitting light emitted by the at least one LED-based lighting unit, and (iii) a bezel removably attached to the housing. The method includes the acts of rotating the bezel about a pivot point away from the housing, removing the lens to provide access to the at least one LED-based lighting unit of the lighting apparatus, replacing the lens or placing a replacement lens, and rotating the bezel about the pivot point toward the housing to sealably secure the lens against the housing.

In yet another aspect, the invention relates to a lighting apparatus, comprising an LED-based lighting fixture including a housing having an outer rim and at least one LED-based lighting unit disposed in the housing. The apparatus further comprises a face panel having a lens portion for transmitting light emitted by the at least one LED-based lighting unit, a bezel pivotably mounted to the housing by a non-adhesive connector and adapted to sealably secure the face panel against the housing, and a flexible sleeve removably fitted over the lighting fixture and covering at least a portion of the outer rim and at least a portion of the bezel. The flexible sleeve comprises a thermoplastic elastomeric material and having dimensions selected to allow the sleeve to be removably affixed to the lighting fixture by a compressive force fit.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 includes frontal and rear perspective views of a conventional LED-based lighting fixture;

FIG. 2 is a diagram illustrating a lighting unit in accordance with various embodiments of the invention;

FIG. 3 is a diagram illustrating a networked lighting system according to various embodiment of the invention;

FIG. 4A is a perspective view of a versatile, impact-resistant LED lighting apparatus in accordance with one embodiment of the invention;

FIGS. 4B-4C are partial, front and rear perspective views, respectively, of the lighting apparatus of FIG. 4A;

FIG. 5 is a partial, exploded view of the lighting apparatus of FIGS. 4A-4C; and

FIG. 6 is a partial, perspective view of the lighting apparatus of FIGS. 4A-5, illustrating a method in accordance with the present invention for inserting/removing the lens of the lighting apparatus of FIGS. 4A-5.

### DETAILED DESCRIPTION

Following below are more detailed descriptions of various concepts related to, and embodiments of, apparatus and methods according to the present invention for a versatile, impact-resistant lighting apparatus and, in particular, for LED-based lighting fixtures suitable for repeated installations, and for a protective sleeve and lens-retaining bezel for such fixtures. In particular, in various embodiments of the invention, a removable, flexible sleeve is fitted over a lighting fixture to provide numerous advantages, such as impact and scratch protection for the fixture. In various embodiments, a pivotal bezel is removably connected to the housing and sealably secures the face panel of the lighting fixture to the housing, further enhancing impact resistance and facilitating repairs and maintenance of the lighting apparatus, thereby minimizing downtime. It should be appreciated that various aspects of the invention, as discussed above and outlined further below, may be implemented in any of numerous ways, as the invention is not limited to any particular manner of implementation. Examples of specific implementations are provided for illustrative purposes only. For example, while various embodiments of the invention are described in conjunction with LED-based lighting fixtures, certain inventive concepts described and claimed herein are applicable to lighting fixtures employing conventional non-LED light sources, without deviating from the scope and spirit of the invention.

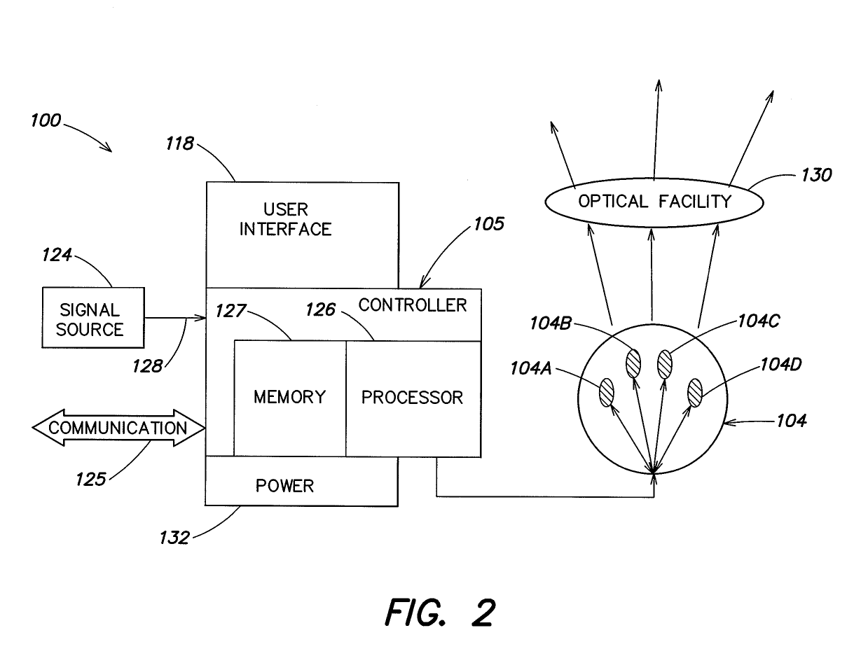

FIG. 2 illustrates one example of a lighting unit 100 according to one embodiment of the present disclosure. Some general examples of LED-based lighting units similar to those that are described below in connection with FIG. 2 may be found, for example, in U.S. Pat. No. 6,016,038, issued Jan. 18, 2000 to Mueller et al., entitled “Multicolored LED Lighting Method and Apparatus,” and U.S. Pat. No. 6,211,626, issued Apr. 3, 2001 to Lys et al, entitled “Illumination Components,” which patents are both hereby incorporated herein by reference.

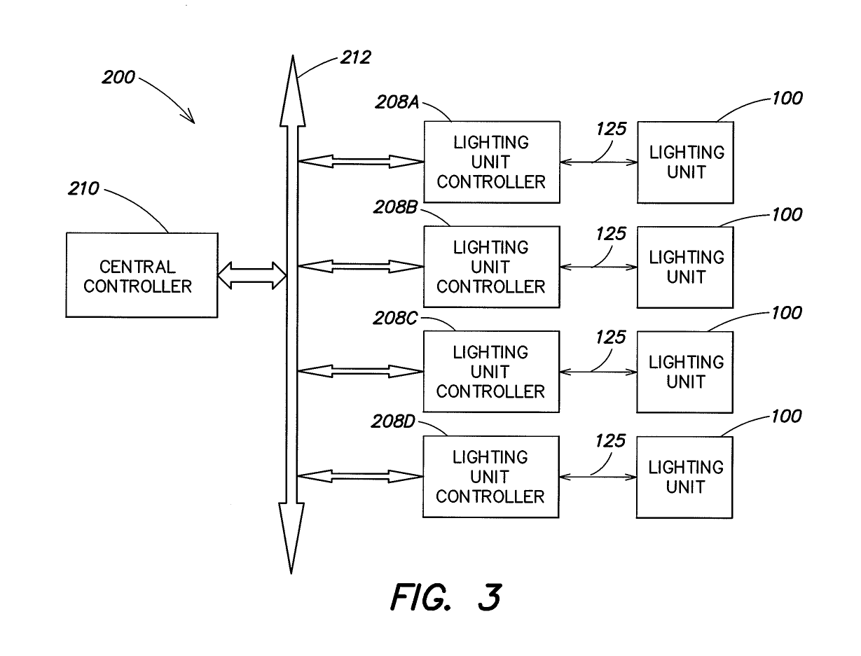

The lighting unit 100 shown in FIG. 2 may be used alone or together with other similar lighting units in a system of lighting units (e.g., as discussed further below in connection with FIG. 3). Used alone or in combination with other lighting units, the lighting unit 100 may be employed in a variety of applications including, but not limited to, interior or exterior space (e.g., architectural) lighting and illumination in general, direct or indirect illumination of objects or spaces, and theatrical or other entertainment-based/special effects lighting. In various implementations and embodiments, the lighting unit 100 shown in FIG. 2 includes one or more light sources 104A, 104B, 104C, and 104D (shown collectively as 104), wherein one or more of the light sources may be an LED-based light source that includes one or more light emitting diodes (LEDs). In one aspect of this embodiment, any two or more of the light sources may be adapted to generate radiation of different colors (e.g. red, green, blue); in this respect, as discussed above, each of the different color light sources generates a different source spectrum that constitutes a different “channel” of a “multi-channel” lighting unit. Although FIG. 2 shows four light sources 104A, 104B, 104C, and 104D, it should be appreciated that the lighting unit is not limited in this respect, as different numbers and various types of light sources (all LED-based light sources, LED-based and non-LED-based light sources in combination, etc.) adapted to generate radiation of a variety of different colors, including essentially white light, may be employed in the lighting unit 100, as discussed further below.

As shown in FIG. 2, the lighting unit 100 also may include a controller 105 that is configured to output one or more control signals to drive the light sources so as to generate various intensities of light from the light sources. For example, in one implementation, the controller 105 may be configured to output at least one control signal for each light source so as to independently control the intensity of light (e.g., radiant power in lumens) generated by each light source; alternatively, the controller 105 may be configured to output one or more control signals to collectively control a group of two or more light sources identically. Some examples of control signals that may be generated by the controller to control the light sources include, but are not limited to, pulse modulated signals, pulse width modulated signals (PWM), pulse amplitude modulated signals (PAM), pulse code modulated signals (PCM) analog control signals (e.g., current control signals, voltage control signals), combinations and/or modulations of the foregoing signals, or other control signals. In one aspect, particularly in connection with LED-based sources, one or more modulation techniques provide for variable control using a fixed current level applied to one or more LEDs, so as to mitigate potential undesirable or unpredictable variations in LED output that may arise if a variable LED drive current were employed. In another aspect, the controller 105 may control other dedicated circuitry (not shown in FIG. 2) which in turn controls the light sources so as to vary their respective intensities.

In general, the intensity (radiant output power) of radiation generated by the one or more light sources is proportional to the average power delivered to the light source(s) over a given time period. Accordingly, one technique for varying the intensity of radiation generated by the one or more light sources involves modulating the power delivered to (i.e., the operating power of) the light source(s). For some types of light sources, including LED-based sources, this may be accomplished effectively using a pulse width modulation (PWM) technique.

In one exemplary implementation of a PWM control technique, for each channel of a lighting unit a fixed predetermined voltage V_{source} is applied periodically across a given light source constituting the channel. The application of the voltage V_{source} may be accomplished via one or more switches, not shown in FIG. 2, controlled by the controller 105. While the voltage V_{source} is applied across the light source, a predetermined fixed current I_{source (}e.g., determined by a current regulator, also not shown in FIG. 2) is allowed to flow through the light source. Again, recall that an LED-based light source may include one or more LEDs, such that the voltage V_{source} may be applied to a group of LEDs constituting the source, and the current I_{source} may be drawn by the group of LEDs. The fixed voltage V_{source} across the light source when energized, and the regulated current I_{source} drawn by the light source when energized, determines the amount of instantaneous operating power P_{source} of the light source (P_{source}=V_{source}·I_{source}). As mentioned above, for LED-based light sources, using a regulated current mitigates potential undesirable or unpredictable variations in LED output that may arise if a variable LED drive current were employed. According to the PWM technique, by periodically applying the voltage V_{source} to the light source and varying the time the voltage is applied during a given on-off cycle, the average power delivered to the light source over time (the average operating power) may be modulated. In particular, the controller 105 may be configured to apply the voltage V_{source} to a given light source in a pulsed fashion (e.g., by outputting a control signal that operates one or more switches to apply the voltage to the light source), preferably at a frequency that is greater than that capable of being detected by the human eye (e.g., greater than approximately 100 Hz). In this manner, an observer of the light generated by the light source does not perceive the discrete on-off cycles (commonly referred to as a “flicker effect”), but instead the integrating function of the eye perceives essentially continuous light generation. By adjusting the pulse width (i.e. on-time, or “duty cycle”) of on-off cycles of the control signal, the controller varies the average amount of time the light source is energized in any given time period, and hence varies the average operating power of the light source. In this manner, the perceived brightness of the generated light from each channel in turn may be varied.

As discussed in greater detail below, the controller 105 may be configured to control each different light source channel of a multi-channel lighting unit at a predetermined average operating power to provide a corresponding radiant output power for the light generated by each channel. Alternatively, the controller 105 may receive instructions (e.g., “lighting commands”) from a variety of origins, such as a user interface 118, a signal source 124, or one or more communication ports 125, that specify prescribed operating powers for one or more channels and, hence, corresponding radiant output powers for the light generated by the respective channels. By varying the prescribed operating powers for one or more channels (e.g., pursuant to different instructions or lighting commands), different perceived colors and brightness levels of light may be generated by the lighting unit.

In one embodiment of the lighting unit 100, as mentioned above, one or more of the light sources 104A, 104B, 104C, and 104D shown in FIG. 2 may include a group of multiple LEDs or other types of light sources (e.g., various parallel and/or serial connections of LEDs or other types of light sources) that are controlled together by the controller 105. Additionally, it should be appreciated that one or more of the light sources may include one or more LEDs that are adapted to generate radiation having any of a variety of spectra (i.e., wavelengths or wavelength bands), including, but not limited to, various visible colors (including essentially white light), various color temperatures of white light, ultraviolet, or infrared. LEDs having a variety of spectral bandwidths (e.g., narrow band, broader band) may be employed in various implementations of the lighting unit 100.

In another aspect of the lighting unit 100 shown in FIG. 2, the lighting unit 100 may be constructed and arranged to produce a wide range of variable color radiation. For example, in one embodiment, the lighting unit 100 may be particularly arranged such that controllable variable intensity (i.e., variable radiant power) light generated by two or more of the light sources combines to produce a mixed colored light (including essentially white light having a variety of color temperatures). In particular, the color (or color temperature) of the mixed colored light may be varied by varying one or more of the respective intensities (output radiant power) of the light sources (e.g., in response to one or more control signals output by the controller 105). Furthermore, the controller 105 may be particularly configured to provide control signals to one or more of the light sources so as to generate a variety of static or time-varying (dynamic) multi-color (or multi-color temperature) lighting effects. To this end, in one embodiment, the controller may include a processor 126 (e.g., a microprocessor) programmed to provide such control signals to one or more of the light sources. In various aspects, the processor 126 may be programmed to provide such control signals autonomously, in response to lighting commands, or in response to various user or signal inputs.

Thus, the lighting unit 100 may include a wide variety of colors of LEDs in various combinations, including two or more of red, green, and blue LEDs to produce a color mix, as well as one or more other LEDs to create varying colors and color temperatures of white light. For example, red, green and blue can be mixed with amber, white, UV, orange, IR or other colors of LEDs. Additionally, multiple white LEDs having different color temperatures (e.g., one or more first white LEDs that generate a first spectrum corresponding to a first color temperature, and one or more second white LEDs that generate a second spectrum corresponding to a second color temperature different than the first color temperature) may be employed, in an all-white LED lighting unit or in combination with other colors of LEDs. Such combinations of differently colored LEDs and/or different color temperature white LEDs in the lighting unit 100 can facilitate accurate reproduction of a host of desirable spectrums of lighting conditions, examples of which include, but are not limited to, a variety of outside daylight equivalents at different times of the day, various interior lighting conditions, lighting conditions to simulate a complex multicolored background, and the like. Other desirable lighting conditions can be created by removing particular pieces of spectrum that may be specifically absorbed, attenuated or reflected in certain environments. Water, for example tends to absorb and attenuate most non-blue and non-green colors of light, so underwater applications may benefit from lighting conditions that are tailored to emphasize or attenuate some spectral elements relative to others.

As shown in FIG. 2, the lighting unit 100 also may include a memory 127 to store information. For example, the memory 127 may be employed to store one or more lighting commands or programs for execution by the processor 126 (e.g., to generate one or more control signals for the light sources), as well as various types of data useful for generating variable color radiation (e.g., calibration information, discussed further below). The memory 127 also may store one or more particular identifiers (e.g., a serial number, an address, etc.) that may be used either locally or on a system level to identify the lighting unit 100. In various embodiments, such identifiers may be pre-programmed by a manufacturer, for example, and may be either alterable or non-alterable thereafter (e.g., via some type of user interface located on the lighting unit, via one or more data or control signals received by the lighting unit, etc.). Alternatively, such identifiers may be determined at the time of initial use of the lighting unit in the field, and again may be alterable or non-alterable thereafter.

Still referring to FIG. 2, the lighting unit 100 optionally may include one or more user interfaces 118 that are provided to facilitate any of a number of user-selectable settings or functions (e.g., generally controlling the light output of the lighting unit 100, changing and/or selecting various pre-programmed lighting effects to be generated by the lighting unit, changing and/or selecting various parameters of selected lighting effects, setting particular identifiers such as addresses or serial numbers for the lighting unit, etc.). In various embodiments, the communication between the user interface 118 and the lighting unit may be accomplished through wire or cable, or wireless transmission. In one implementation, the controller 105 of the lighting unit monitors the user interface 118 and controls one or more of the light sources 104A, 104B, 104C and 104D based at least in part on a user's operation of the interface. For example, the controller 105 may be configured to respond to operation of the user interface by originating one or more control signals for controlling one or more of the light sources. Alternatively, the processor 126 may be configured to respond by selecting one or more pre-programmed control signals stored in memory, modifying control signals generated by executing a lighting program, selecting and executing a new lighting program from memory, or otherwise affecting the radiation generated by one or more of the light sources.

In particular, in one implementation, the user interface 118 may constitute one or more switches (e.g., a standard wall switch) that interrupt power to the controller 105. In one aspect of this implementation, the controller 105 is configured to monitor the power as controlled by the user interface, and in turn control one or more of the light sources based at least in part on a duration of a power interruption caused by operation of the user interface. As discussed above, the controller may be particularly configured to respond to a predetermined duration of a power interruption by, for example, selecting one or more pre-programmed control signals stored in memory, modifying control signals generated by executing a lighting program, selecting and executing a new lighting program from memory, or otherwise affecting the radiation generated by one or more of the light sources.

FIG. 2 also illustrates that the lighting unit 100 may be configured to receive one or more signals 128 from one or more other signal sources 124. In one implementation, the controller 105 of the lighting unit may use the signal(s) 128, either alone or in combination with other control signals (e.g., signals generated by executing a lighting program, one or more outputs from a user interface, etc.), so as to control one or more of the light sources 104A, 104B, 104C and 104D in a manner similar to that discussed above in connection with the user interface.

Examples of the signal(s) 128 that may be received and processed by the controller 105 include, but are not limited to, one or more audio signals, video signals, power signals, various types of data signals, signals representing information obtained from a network (e.g., the Internet), signals representing one or more detectable/sensed conditions, signals from lighting units, signals consisting of modulated light, etc. In various implementations, the signal source(s) 124 may be located remotely from the lighting unit 100, or included as a component of the lighting unit. In one embodiment, a signal from one lighting unit 100 could be sent over a network to another lighting unit 100.

In one embodiment, the lighting unit 100 shown in FIG. 2 also may include one or more optical elements 130 to optically process the radiation generated by the light sources 104A, 104B, 104C, and 104D. For example, one or more optical elements may be configured so as to change one or both of a spatial distribution and a propagation direction of the generated radiation. In particular, one or more optical elements may be configured to change a diffusion angle of the generated radiation. In one aspect of this embodiment, one or more optical elements 130 may be particularly configured to variably change one or both of a spatial distribution and a propagation direction of the generated radiation (e.g., in response to some electrical and/or mechanical stimulus). Examples of optical elements that may be included in the lighting unit 100 include, but are not limited to, reflective materials, refractive materials, translucent materials, filters, lenses, mirrors, and fiber optics. The optical element 130 also may include a phosphorescent material, luminescent material, or other material capable of responding to or interacting with the generated radiation.

As also shown in FIG. 2, the lighting unit 100 may include one or more communication ports 125 to facilitate coupling of the lighting unit 100 to any of a variety of other devices. For example, one or more communication ports 125 may facilitate coupling multiple lighting units together as a networked lighting system, in which at least some of the lighting units are addressable (e.g., have particular identifiers or addresses) and are responsive to particular data transported across the network.

In particular, in a networked lighting system environment, as discussed in greater detail further below (e.g., in connection with FIG. 3), as data is communicated via the network, the controller 105 of each lighting unit coupled to the network may be configured to be responsive to particular data (e.g., lighting control commands) that pertain to it (e.g., in some cases, as dictated by the respective identifiers of the networked lighting units). Once a given controller identifies particular data intended for it, it may read the data and, for example, change the lighting conditions produced by its light sources according to the received data (e.g., by generating appropriate control signals to the light sources). In one aspect, the memory 127 of each lighting unit coupled to the network may be loaded, for example, with a table of lighting control signals that correspond with data the processor 126 of the controller receives. Once the processor 126 receives data from the network, the processor may consult the table to select the control signals that correspond to the received data, and control the light sources of the lighting unit accordingly.

In one aspect of this embodiment, the processor 126 of a given lighting unit, whether or not coupled to a network, may be configured to interpret lighting instructions/data that are received in a DMX protocol (as discussed, for example, in U.S. Pat. Nos. 6,016,038 and 6,211,626), which is a lighting command protocol conventionally employed in the lighting industry for some programmable lighting applications. For example, in one aspect, considering for the moment a lighting unit based on red, green and blue LEDs (i.e., an “R-G-B” lighting unit), a lighting command in DMX protocol may specify each of a red channel command, a green channel command, and a blue channel command as eight-bit data (i.e., a data byte) representing a value from 0 to 255. The maximum value of 255 for any one of the color channels instructs the processor 126 to control the corresponding light source(s) to operate at maximum available power (i.e., 100%) for the channel, thereby generating the maximum available radiant power for that color (such a command structure for an R-G-B lighting unit commonly is referred to as 24-bit color control). Hence, a command of the format [R, G, B]=[255, 255, 255] would cause the lighting unit to generate maximum radiant power for each of red, green and blue light (thereby creating white light).

It should be appreciated, however, that lighting units suitable for purposes of the present disclosure are not limited to a DMX command format, as lighting units according to various embodiments may be configured to be responsive to other types of communication protocols/lighting command formats so as to control their respective light sources. In general, the processor 126 may be configured to respond to lighting commands in a variety of formats that express prescribed operating powers for each different channel of a multi-channel lighting unit according to some scale representing zero to maximum available operating power for each channel.

In one embodiment, the light source 104 may include and/or be coupled to one or more power sources 132. In various aspects, examples of power source(s) 132 include, but are not limited to, AC power sources, DC power sources, batteries, solar-based power sources, thermoelectric or mechanical-based power sources and the like. Additionally, in one aspect, the power source(s) 132 may include or be associated with one or more power conversion devices or power conversion circuitry (e.g., in some cases internal to the light source 104) that convert power received by an external power source to a form suitable for operation of the various internal circuit components and light sources of the light source 104. In one exemplary implementation discussed in U.S. Pat. No. 7,256,554, entitled “LED Power Control Methods and Apparatus;” incorporated herein by reference, the controller 105 of the light source 104 may be configured to accept a standard A.C. line voltage from the power source 132 and provide appropriate D.C. operating power for the light sources and other circuitry of the lighting unit based on concepts related to DC-DC conversion, or “switching” power supply concepts. In one aspect of such implementations, the controller 105 may include circuitry to not only accept a standard A.C. line voltage but to ensure that power is drawn from the line voltage with a significantly high power factor.

FIG. 3 illustrates an example of a networked lighting system 200 according to one embodiment of the present disclosure. In the embodiment of FIG. 3, a number of lighting units 100, similar to those discussed above in connection with FIG. 2, are coupled together to form the networked lighting system. It should be appreciated, however, that the particular configuration and arrangement of lighting units shown in FIG. 3 is for purposes of illustration only, and that the disclosure is not limited to the particular system topology shown in FIG. 3.

Additionally, while not shown explicitly in FIG. 3, it should be appreciated that the networked lighting system 200 may be configured flexibly to include one or more user interfaces, as well as one or more signal sources such as sensors/transducers. For example, one or more user interfaces and/or one or more signal sources such as sensors/transducers (as discussed above in connection with FIG. 2) may be associated with any one or more of the lighting units of the networked lighting system 200. Alternatively (or in addition to the foregoing), one or more user interfaces and/or one or more signal sources may be implemented as “stand alone” components in the networked lighting system 200. Whether stand alone components or particularly associated with one or more lighting units 100, these devices may be “shared” by the lighting units of the networked lighting system. Stated differently, one or more user interfaces and/or one or more signal sources such as sensors/transducers may constitute “shared resources” in the networked lighting system that may be used in connection with controlling any one or more of the lighting units of the system.

As shown in the embodiment of FIG. 3, the lighting system 200 may include one or more lighting unit controllers (hereinafter “LUCs”) 208A, 208B, 208C, and 208D, wherein each LUC is responsible for communicating with and generally controlling one or more lighting units 100 coupled to it. Although FIG. 3 illustrates one lighting unit 100 coupled to each LUC, it should be appreciated that the disclosure is not limited in this respect, as different numbers of lighting units 100 may be coupled to a given LUC in a variety of different configurations (serially connections, parallel connections, combinations of serial and parallel connections, etc.) using a variety of different communication media and protocols.

In the system of FIG. 3, each LUC in turn may be coupled to a central controller 210 that is configured to communicate with one or more LUCs. Although FIG. 3 shows four LUCs coupled to the central controller 210 via a generic connection 212 (which may include any number of a variety of conventional coupling, switching and/or networking devices), it should be appreciated that according to various embodiments, different numbers of LUCs may be coupled to the central controller 210. Additionally, according to various embodiments of the present disclosure, the LUCs and the central controller may be coupled together in a variety of configurations using a variety of different communication media and protocols to form the networked lighting system 200. Moreover, it should be appreciated that the interconnection of LUCs and the central controller, and the interconnection of lighting units to respective LUCs, may be accomplished in different manners (e.g., using different configurations, communication media, and protocols).

For example, according to one embodiment of the present disclosure, the central controller 210 shown in FIG. 3 may by configured to implement Ethernet-based communications with the LUCs, and in turn the LUCs may be configured to implement DMX-based communications with the lighting units 100. In particular, in one aspect of this embodiment, each LUC may be configured as an addressable Ethernet-based controller and accordingly may be identifiable to the central controller 210 via a particular unique address (or a unique group of addresses) using an Ethernet-based protocol. In this manner, the central controller 210 may be configured to support Ethernet communications throughout the network of coupled LUCs, and each LUC may respond to those communications intended for it. In turn, each LUC may communicate lighting control information to one or more lighting units coupled to it, for example, via a DMX protocol, based on the Ethernet communications with the central controller 210.

More specifically, according to one embodiment, the LUCs 208A, 208B, and 208C shown in FIG. 3 may be configured to be “intelligent” in that the central controller 210 may be configured to communicate higher level commands to the LUCs that need to be interpreted by the LUCs before lighting control information can be forwarded to the lighting units 100. For example, a lighting system operator may want to generate a color changing effect that varies colors from lighting unit to lighting unit in such a way as to generate the appearance of a propagating rainbow of colors (“rainbow chase”), given a particular placement of lighting units with respect to one another. In this example, the operator may provide a simple instruction to the central controller 210 to accomplish this, and in turn the central controller may communicate to one or more LUCs using an Ethernet-based protocol high level command to generate a “rainbow chase.” The command may contain timing, intensity, hue, saturation or other relevant information, for example. When a given LUC receives such a command, it may then interpret the command and communicate further commands to one or more lighting units using a DMX protocol, in response to which the respective sources of the lighting units are controlled via any of a variety of signaling techniques (e.g., PWM).

It should again be appreciated that the foregoing example of using multiple different communication implementations (e.g., Ethernet/DMX) in a lighting system according to one embodiment of the present disclosure is for purposes of illustration only, and that the disclosure is not limited to this particular example.

From the foregoing, it may be appreciated that one or more lighting units as discussed above are capable of generating highly controllable variable color light over a wide range of colors, as well as variable color temperature white light over a wide range of color temperatures.

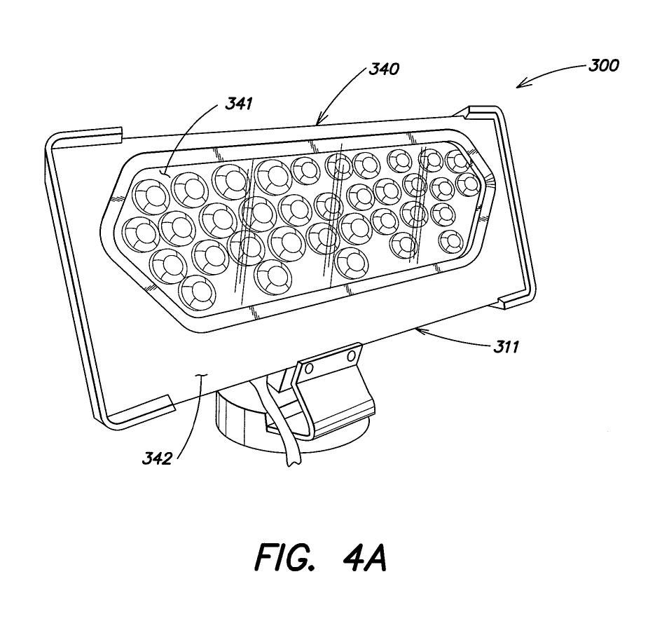

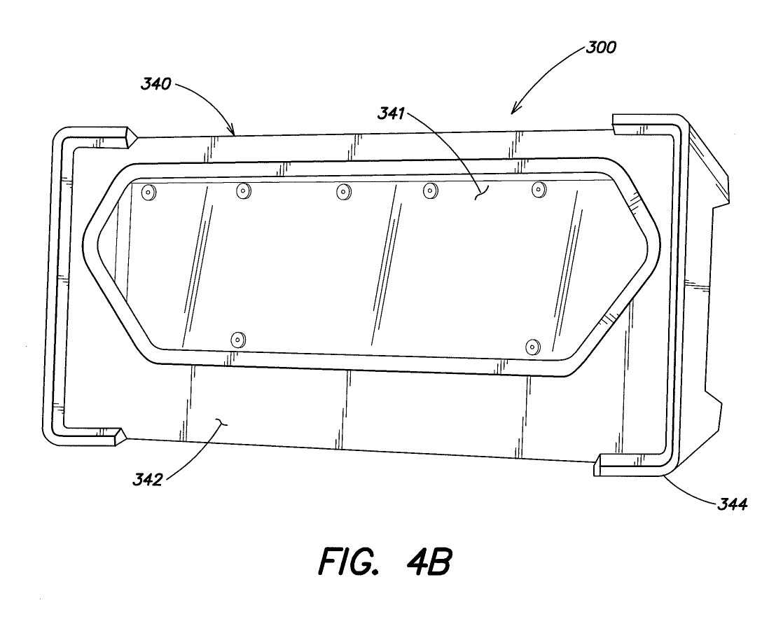

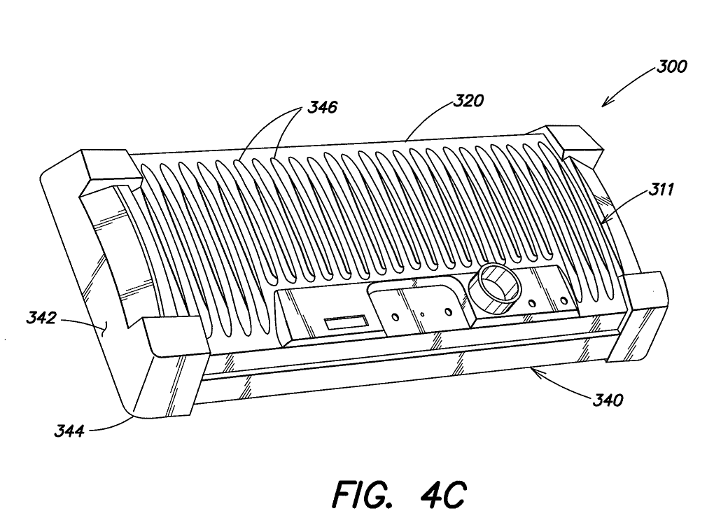

FIGS. 4A, 4B and 4C illustrate a lighting apparatus 300 according to one embodiment of the present invention. The lighting apparatus 300 comprises a lighting fixture 311 and a protective flexible sleeve 340 that is removably fitted over the lighting fixture 311. Due at least in part to the advantages provided by the protective flexible sleeve 340, as discussed in greater detail below, the LED lighting apparatus 300 is particularly suitable for repeated installations and rugged handling associated therewith.

In various embodiments of the invention, the lighting fixture 311 of the apparatus 300 shown in FIGS. 4A, 4B and 4C may include one or more LED-based lighting units 100, as discussed above in connection with FIGS. 2 and 3, for providing multi-color radiation. Particularly, the lighting fixture 311 preferably includes at least one such LED-based lighting unit, in which a first set of LED light sources is adapted to output a first radiation having a first spectrum and a second set of LED light sources is adapted to output a second radiation having a second spectrum different from the first spectrum. The at least one lighting unit of the fixture further includes at least one controller coupled to the LED light sources as described in connection with FIG. 2 and configured to independently control the radiation from LED light sources, so as to controllably vary at least the overall perceivable color or color temperature of the visible radiation. The lighting fixture 311 may provide ambient illumination including visible radiation in an environment occupied by an observer of the ambient illumination. In various embodiments of the invention, the lighting apparatus 300 including the lighting fixture 311 is part of a network of lighting apparatus, such as a network of lighting apparatus 300, configured in a manner described with reference to FIG. 3 above. In these applications, the controller of at least one LED-based lighting unit in each lighting apparatus 300 is an addressable controller capable of receiving a network signal, which includes information such as lighting information relating to the overall perceivable color of the visible radiation generated by lighting apparatus 300.

Still referring to FIGS. 4A, 4B and 4C, as noted above, the lighting apparatus 300 further includes a protective flexible sleeve 340, which is removably fitted over the lighting fixture 311. The material and configuration of the flexible sleeve are selected primarily to improve shock absorption and impact resistance of the fixture 311, as well as to shield it from environmental elements. In addition to protecting the fixture itself, the sleeve 340 may also protect technicians, electricians, performers, and the immediate surroundings of the fixture from damage or injury in case the fixture is accidentally disengaged from its position in the lighting installation.

In many embodiments, the sleeve 340 is made from a flexible material, such as a thermoplastic elastomeric material (e.g., by injection-molding). For example, the sleeve can be formed from SANTOPRENE 101-80 rubber, available from Advance Elastomer Systems located in Akron, Ohio. The dimensions of the sleeve are selected to allow it to be removably and snugly fitted over the lighting fixture 311 by a compressive force. In various aspects, the thermoplastic elastomeric material, the thickness of the sleeve, and/or the extent of coverage of the sleeve over various portions of the fixture 311 are selected to provide a predetermined degree of shock absorption and impact resistance. For example, the variables can be set to prevent breakage for at least a certain percentage of falls from a selected height, e.g. four feet. These variables are further selected to allow the sleeve to be fitted to and removed from fixture 311 with ease, e.g., manually stretching it over the corners of the fixture 311. While FIGS. 4A, 4B and 4C depict the flexible sleeve 340 as covering an entire outer rim of the lighting fixture 311, it should be appreciated that in other embodiments, the sleeve may cover only a portion of the outer rim.

In general, a flexible sleeve in accordance with the invention is for use with lighting fixtures having temperatures that are cool enough to prevent during operation of the fixture the melting of the flexible sleeve and prevent the softening thereof to an extent which would inhibit its protective function. For example, excessive softening occurs when the operating temperature is high enough to cause the sleeve to fall off of the fixture and/or lose its compressive force fit to the fixture.

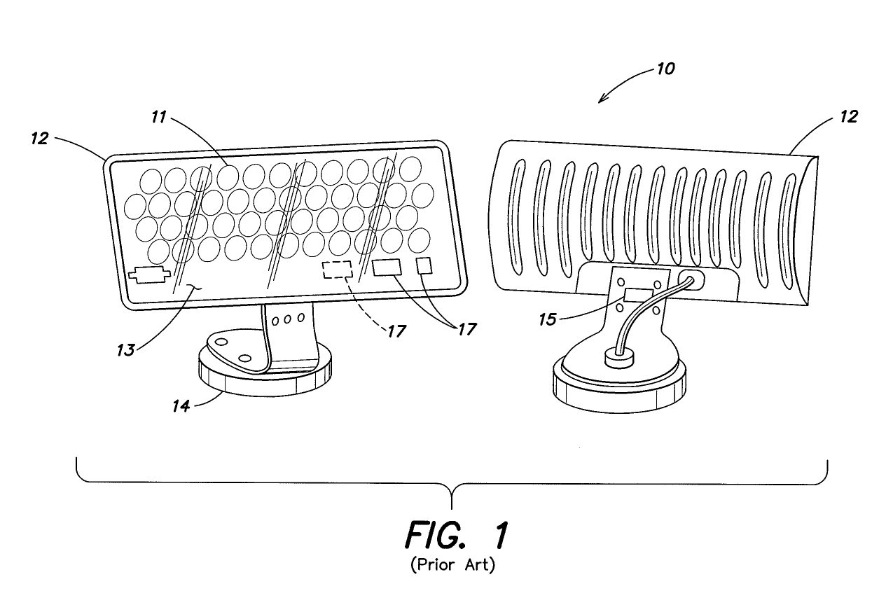

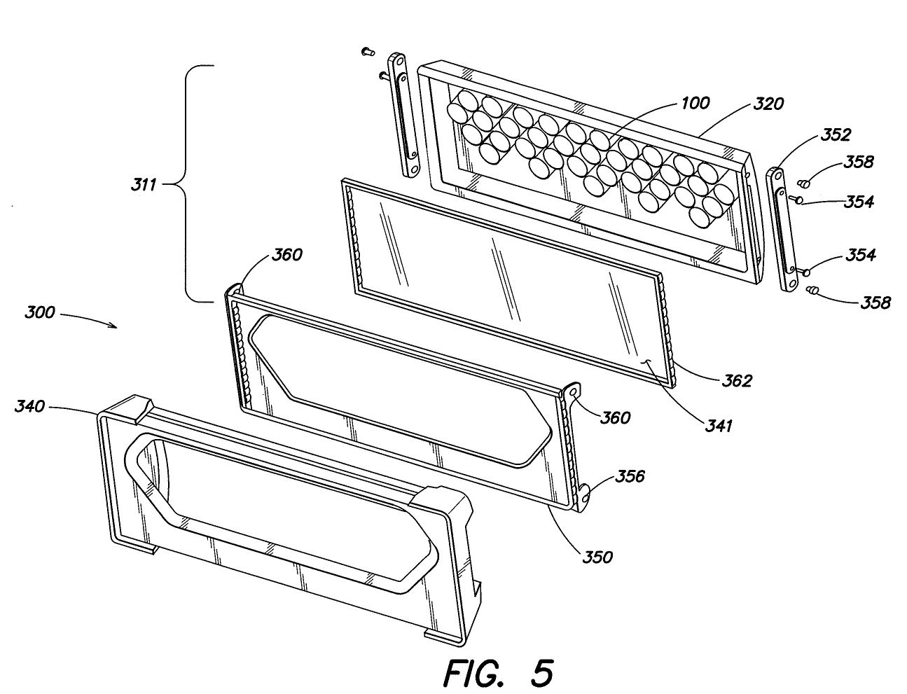

As shown in FIGS. 4A and 4B, a protective surface 342 of the sleeve 340 may cover a portion of a front surface or “face panel” 341 of the lighting fixture 311 from which light emanates. In exemplary implementations, this protective surface 342 of the sleeve 340 may have a nominal thickness of approximately 0.100 inches to 0.125 inches. In one aspect, as discussed in more detail below in conjunction with FIG. 5, a substantial portion of the face panel 341 may be a transparent or translucent cover and may define a lens, diffuser, or other optical element or cover for transmitting radiation emitted by the lighting fixture. In another aspect, the face panel 341 may also include an opaque portion, for example, configured to conceal electronic circuitry of the fixture 311 (e.g., see the electronic components 17 discussed above in connection with FIG. 1). In some embodiments of the invention, the sleeve 340 (e.g., the protective surface 342 of the sleeve) covers at least 20% of the lighting fixture's face panel, leaving generally the transparent portion of the face panel exposed. In other embodiments of the invention, the sleeve 340 covers at least 40% of the face panel. In one particular embodiment, and as illustrated in FIGS. 4A and 4B, the sleeve 340 covers about 60% of the face panel.

In addition to improved shock absorption and impact resistance, several additional advantages are realized by the sleeve 340. For example, because it is secured over the lighting fixture 311 by a compressive force, the snug fit of sleeve 340 may mitigate the movement of constituent parts of the fixture 311 relative to one another. By being fitted over at least a portion of the fixture's housing 320 (see FIG. 4C), the sleeve protects the entirety of the fixture, not merely its light-emitting elements. The flexible nature of the sleeve further allows it to be readily removed and replaced without any specialized tools, thereby simplifying access to the fixture for repairs or maintenance while providing improved impact protection. By covering any potential gaps between mating surfaces of constituent parts of the fixture, such as the face panel and housing, described in greater detail with reference to FIG. 5, the sleeve 340 further provides protection from deleterious elements, such as moisture and dust, which can cause damage to the electronic components of the fixture 311.

Referring to FIGS. 4B-4C, in accordance with various embodiments of the invention, the protective surface 342 of the sleeve 340 is disposed proximate to a surface of the fixture's face panel 341. The protective surface 342 is offset from the surface of the face panel to increase the protection of the translucent or transparent portion of the face panel (e.g., a lens, diffuser or other optical element or cover) from breakage and scratching. Additional protection is provided, in various embodiments of the invention, by expanding or providing additional padding in the sleeve 340 at or near the rim of the housing 320. As illustrated in FIGS. 4B-4C, an outer section, e.g. the corners, of the sleeve are padded to define corner surfaces 344, which are offset from the protective surface 342. Preferably, the thickness of the sleeve 340 is greater at a corner portion thereof than at the protective surface 342. For example, corner surfaces 344 can be offset from protective surface 342 by an additional 0.188 inches. Among other things, the padded corners and/or edges provide a greater degree of motion for absorbing and/or deflecting impacts to the lighting apparatus 300, thereby further enhancing its ruggedness, versatility, and portability.

In various embodiments of the invention, the flexible sleeve 340 is opaque. This feature provides several benefits. First, it aids in the control of spill light and provides a certain degree of beam control, as contrasted to a transparent material. Furthermore, in implementations in which most or all of the lighting fixture's face panel 341 is substantially transparent or translucent and electronic components of the fixture are visible through the face panel (e.g., see components 17 of FIG. 1), an opaque protective surface 342 of the flexible sleeve may conceal electronic components of the lighting fixture from viewers, thereby providing a “cleaner”, less distracting appearance. By allowing the placement of the electronic components within the same general planes as the light-emitting elements, the lighting apparatus 300 can be imparted a more sleek and compact design than a lighting fixture in which electronic components (e.g., driver and power control circuitry) are disposed beneath the LEDs in a different plane, thereby allowing more versatility with respect to placement in a theatrical set or other lighting environment. As illustrated in FIG. 4C, in various embodiments of the invention, the flexible sleeve 340 is configured to expose heat-dissipation surfaces 346 of the housing 320 to the ambient environment, thereby facilitating heat removal and prolonging the life of the fixture.

Referring to FIG. 5, another inventive aspect of the present invention generally relates to facilitating access to the lighting fixture's face panel 341, and components of the lighting fixture below the face panel (e.g., one or more lighting units or light sources, various electronic circuitry, etc.). Access to these elements facilitates repairs and maintenance and reduces downtime of lighting fixtures, such as theatrical and rental lighting fixtures, which are frequently moved, mounted and dismounted. In accordance with one embodiment of the present invention, the LED-based lighting fixture 311 of the lighting apparatus 300 includes the housing 320, containing one or more LED-based lighting units 100; a face panel 341 for transmitting light emitted by LED-based lighting units 348; and a bezel 350, disposed between the sleeve 340 and the housing 320, for retaining the face panel 341. As discussed above, substantially all or some portion of the face panel 341 may include a lens, a diffuser, or other type of translucent or transparent optical element or cover.

Generally, the configuration of the bezel, the face panel, and the housing are selected to enable removal and replacement of the face panel in a manner that reduces the risk of breakage of the face panel during the removal/replacement process. Additionally, the bezel is removably connected to the housing by a non-adhesive connector, so that it may be repeatedly and readily disengaged from and re-engaged with the housing in a manner that does not entail destruction of parts, such as occurs with prior art lighting fixtures, as described with reference to FIG. 1. The bezel is further adapted to sealably secure at least one face panel (e.g., a lens) against the housing. Similar to the sleeve 340, as described above with reference to FIGS. 4A-4C, the bezel 350 increases the protection of the fragile face panel by providing a sturdy structure covering an extended area of the panel.

In various embodiments of the invention, the housing and the lighting units are the same as the analogous parts described with reference to FIG. 1. However, in contrast to prior art fixtures employing an integrated/adhered lens, such as described with reference to FIG. 1, the face panel (e.g., lens) 341 is removably secured in the fixture 311 by the bezel 350 without adhesives.

In various embodiments, the bezel 350 is sized to engage the housing 320 about the rim thereof. The bezel can be formed from steel and manufactured by stamping. In a particular embodiment, the bezel has a thickness of about 0.063 inches. For connecting the bezel to the housing, a pair of adapter plates 352 are mounted on housing 320 with a pair of screws 354, fastened into accessory mounting holes in the housing. To provide a pivotable connection of the bezel to the housing, the bezel has a pair of holes 356 formed at its lower half for receiving screws 358, which are fastened into adapter plates 352. Another pair of holes 360 is provided at the top of bezel 350 for securing its upper side to adapter plates 352 with a second pair of screws 358. In other embodiments of the present invention, a bezel is removably connected to the housing by, for example, a hook/latch structure.

Continuing to refer to FIG. 5, in various embodiments of the invention, a gasket 362 is disposed over the face panel 341 proximate to its outer edge and covering both sides of the face panel, and the housing 320 is configured to sealably receive the gasketed face panel. For example, in various embodiments, the housing has landing surfaces for seating the gasketed face panel thereon. As with the flexible sleeve 340, the gasket aids in protecting the light-emitting and electronic elements of the fixture 311 from exposure to dust and water, thereby enhancing durability of the lighting apparatus 300.

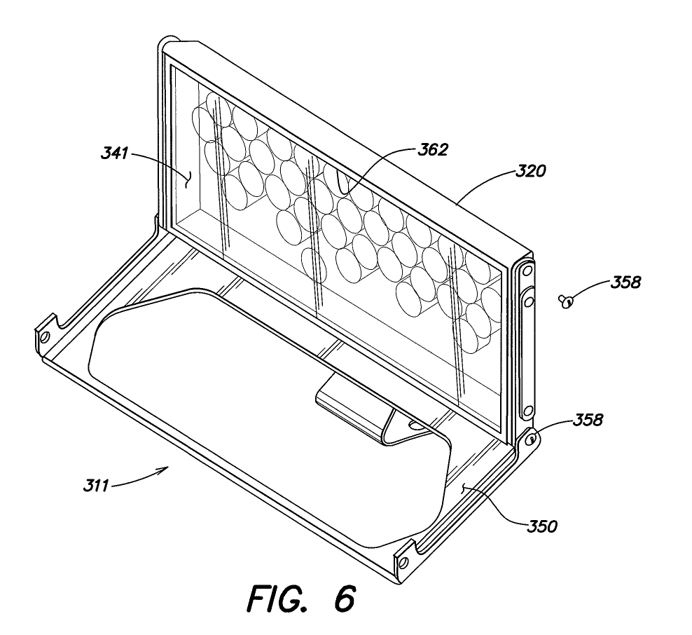

Referring to FIG. 6 and with continued reference to FIG. 5, a method will be described for enabling repairs or maintenance of an LED-based lighting apparatus, in accordance with the invention. The method of the present invention is easy, quick, and greatly reduces a risk of breakage of the face panel 341 (e.g., lens or other optical cover), thereby lowering the costs associated with replacement parts and labor and reducing the risk of injury to users of the lighting fixture. In accordance with the method of the invention, the bezel 350 is disengaged from the housing 320 by first removing upper screws 358 and, then, rotating the bezel about a pivot point at lower screws 358 in a direction away from the housing. In various embodiments, this pivot point is located at lower screws 358. In other embodiments, the axis of rotation is not at the lower edge of the housing, and is, for example, located along a left/right edge of the housing. In this manner, the bezel is easily removed from the housing 320, allowing for easy access to the face panel 341 for replacement or for servicing of electronic components of the fixture.

To reassemble the fixture 311, gasketed face panel 341 or a replacement therefor is first seated into the housing 320. The housing is maintained at an angle so that the lighting units face upwards. In this manner, the forces of gravity and the gasket 362 engaging with the housing retain the face panel 341 during the following steps. Then, the bezel is pivoted about the pivot point in a direction toward the housing, and the screws 358 are used to reattach the upper end of the bezel to the adapter plates 352, thereby sealably securing and retaining the face panel against the housing. In other methods in accordance with the invention, the bezel is further adapted to retain the gasketed face panel so that the face panel is inserted into the bezel, and the bezel-face panel combination is pivotably rotated about a pivot point during the disassembly and reassembly of the fixture. In this manner, for example, a face panel configured as a lens can be switched between, for example, a frosted diffuse glass lens and a clear glass lens, allowing the beam angle to be readily adjusted by the end user.

Thus, a lighting apparatus and method in accordance with the invention provide numerous advantages over the prior art. A protective, flexible sleeve and retaining bezel protect the fixture from damage due to impacts and environmental elements, such as moisture and dust; facilitate maintenance and repairs of the fixture; allow ease of switching/replacing one or more face panels; and protect both the users of the fixture and the immediate environment of the fixture from harm due to contact with the fixture's sharp/hard edges and thermal or electrical contact with the fixture. These benefits increase the versatility, mobility, and durability of the lighting fixture, and are particularly advantageous in fixtures exposed to the rigors of multiple setups and teardowns, such as theatrical lighting fixtures.

What is claimed is:

1. A lighting apparatus, comprising:
an LED-based lighting fixture including a housing having an outer rim and at least one LED-based lighting unit disposed in the housing;
a face panel having a lens portion for transmitting light emitted by the at least one LED-based lighting unit; and
a flexible sleeve removably fitted over the lighting fixture and covering at least a portion of the outer rim and a portion of the face panel.

2. The lighting apparatus of claim 1, wherein the flexible sleeve comprises a thermoplastic elastomeric material and is secured over the lighting fixture by compressive force.

3. The lighting apparatus of claim 1, wherein the flexible sleeve has a protective surface disposed proximate to and offset from a surface of the lens portion of the face panel.

4. The lighting apparatus of claim 3, wherein the flexible sleeve further has an expanded portion disposed proximate to the outer rim, and wherein the expanded portion has a surface offset from the protective surface.

5. The lighting apparatus of claim 4, wherein the outer rim is substantially rectangular, and wherein the expanded portion is disposed over a corner of the outer rim.

6. The lighting apparatus of claim 1, wherein the flexible sleeve is opaque.

7. The lighting apparatus of claim 1, wherein the at least one LED-based lighting unit comprises:
at least one first LED adapted to output a first radiation having a first spectrum;
at least one second LED adapted to output a second radiation having a second spectrum different from the first spectrum; and
at least one controller disposed in the housing and coupled to the at least one first LED and the at least one second LED, the at least one controller configured to independently control at least a first intensity of the first radiation and a second intensity of the second radiation so as to controllably vary at least an overall perceivable color or color temperature of the visible radiation generated by the lighting apparatus, wherein the lighting apparatus is configured to provide ambient illumination including visible radiation in an environment to be occupied by an observer of the ambient illumination, the visible radiation including at least one of the first radiation and the second radiation.

8. The lighting apparatus of claim 7, wherein the at least one controller is configured as an addressable controller capable of receiving at least one network signal including at least first lighting information relating to the overall perceivable color of the visible radiation generated by the lighting apparatus.

9. The lighting apparatus of claim 1, wherein the flexible sleeve covers at least 20% of the face panel of the lighting fixture.

10. The lighting apparatus of claim 9, wherein the flexible sleeve covers about 60% of the face panel of the lighting fixture.

11. The lighting apparatus of claim 1, wherein the housing comprises a heat-dissipation surface, and wherein the flexible sleeve is removably fitted over at least a portion of the housing and is configured to expose the heat dissipation surface to the ambient environment.

12. The lighting apparatus of claim 1, wherein the lighting fixture further comprises a bezel for retaining the face panel, wherein the bezel is disposed between the flexible sleeve and the housing and removably connected to the housing.

13. The lighting apparatus of claim 12, wherein the bezel is pivotably mounted to the housing.

14. A lighting apparatus, comprising:
a housing having at least one LED-based lighting unit disposed therein;
a lens for transmitting light emitted by the at least one LED-based lighting unit; and
a bezel removably connected to the housing by a non-adhesive connector and adapted to sealably secure the lens against the housing.

15. The lighting apparatus of claim 14, further comprising a gasket disposed on the lens proximate to an outer edge thereof.

16. The lighting apparatus of claim 15, wherein the bezel is pivotably mounted to the housing, such that the bezel is disengageable from the housing to allow access to the lens and the at least one LED-based lighting unit of the lighting apparatus.

17. The lighting apparatus of claim 14, wherein the non-adhesive connector includes a screw.

18. The lighting apparatus of claim 14, wherein the at least one LED-based lighting unit comprises:
at least one first LED adapted to output a first radiation having a first spectrum;
at least one second LED adapted to output a second radiation having a second spectrum different from the first spectrum; and
at least one controller disposed in the housing and coupled to the at least one first LED and the at least one second LED, the at least one controller configured to independently control at least a first intensity of the first radiation and a second intensity of the second radiation so as to controllably vary at least an overall perceivable color or color temperature of the visible radiation generated by the lighting apparatus, wherein the lighting apparatus is configured to provide ambient illumination including visible radiation in an environment to be occupied by an observer of the ambient illumination, the visible radiation including at least one of the first radiation and the second radiation.

19. The lighting apparatus of claim 18, wherein the at least one controller is configured as an addressable controller capable of receiving at least one network signal including at least first lighting information relating to the overall perceivable color of the visible radiation generated by the lighting apparatus

20. A flexible sleeve for protecting a lighting fixture, the flexible sleeve comprising a thermoplastic elastomeric material and having dimensions selected to allow the sleeve to be removably affixed to the lighting fixture by a compressive force fit.

21. The protective flexible sleeve of claim 20, wherein the thermoplastic elastomeric material and a thickness of the sleeve are selected to provide a predetermined degree of shock absorption and impact resistance.

22. The protective flexible sleeve of claim 20, wherein the flexible sleeve is adapted to cover at least 20% of a face panel of the lighting fixture.

23. A method for enabling repairs or maintenance of an LED-based lighting apparatus, the apparatus comprising (i) a housing having at least one LED-based lighting unit disposed therein; (ii) a lens associated with the housing for transmitting light emitted by the at least one LED-based lighting unit; and (iii) a bezel removably attached to the housing, the method comprising:
rotating the bezel about a pivot point in a direction away from the housing;
removing the lens, thereby providing access to the at least one LED-based lighting unit of the lighting apparatus;
replacing the lens or placing a replacement lens; and
rotating the bezel about the pivot point in a direction toward the housing to sealably secure the lens against the housing.

24. The method of claim 23, wherein the act of replacing the lens or placing a replacement lens comprises inserting the lens into the bezel.

25. A lighting apparatus, comprising:
an LED-based lighting fixture including a housing having an outer rim and at least one LED-based lighting unit disposed in the housing;
a face panel having a lens portion for transmitting light emitted by the at least one LED-based lighting unit;
a bezel pivotably mounted to the housing by a non-adhesive connector and adapted to sealably secure the face panel against the housing; and
a flexible sleeve removably fitted over the lighting fixture and covering at least a portion of the outer rim and at least a portion of the bezel, the flexible sleeve comprising a thermoplastic elastomeric material and having dimensions selected to allow the sleeve to be removably affixed to the lighting fixture by a compressive force fit.
